(19) United States
(12) Patent Application Publication
(10) Pub. No.: US 2025/0335015 A1
(43) Pub. Date: Oct. 30, 2025

(54) Technologies for Monitoring Automatic Access Systems and Assessing Performance Thereof

(71) Applicant: SmartAC.com, Inc., Houston, TX (US)

(72) Inventors: Brad Marshall, Houston, TX (US); Andrew Fuselier, Houston, TX (US); Avee Ashokkumar Pansara, Richmond, TX (US)

(21) Appl. No.: 19/007,946

(22) Filed: Jan. 2, 2025

Related U.S. Application Data
(60) Provisional application No. 63/638,292, filed on Apr. 24, 2024.

(51) Int. Cl. G06F 1/30; G06F 11/34

(52) U.S. Cl. CPC G06F 1/30; G06F 11/3466

(57) ABSTRACT

Embodiments relating to a monitoring device and system for analyzing the operation of an automatic access system, such as a garage door opener, are disclosed. The monitoring device is positioned inline within the power supply path to the operator motor unit of the auto-access system and includes electronic circuitry configured to collect and analyze operation data during various operational and idle states. The monitoring device processes this data and can transmit it to a server for further analysis. Upon detection of anomalies or fault conditions, the monitoring device or server generates alerts describing the issues and recommended actions, which are communicated to an electronic device of an individual associated with the access system.

### CROSS-REFERENCE TO RELATED APPLICATIONS

This application claims priority benefit to U.S. Patent Application No. 63/638,292, filed Apr. 24, 2024, which is hereby incorporated by reference in its entirety.

### FIELD

The present disclosure is directed to improvements related to monitoring automatic access systems and assessing performance thereof.

### BACKGROUND

Automatic access systems, such as those used for garage doors, security gates, and access doors, typically use various mechanical and electronic components such as motors, balancing torsion or extension springs, rollers and guide tracks, bearings, and hinges, among other components. These components provide secure, “hands-free” access to both indoor and outdoor spaces. The mechanical and electronic components employed in these systems wear over time from regular use, where wear and tear on the overall system is often exaggerated due to no obvious indication of a situation where maintenance would be helpful or needed. This leads to a set of worn or damaged components, thus creating suboptimal conditions for the overall system. Additionally, any failure presents a risk of personal injury and/or property damage, for example if a door/gate stops halfway or falls on a person or object. The system typically operates under these suboptimal conditions for extended periods of time, which causes accelerated wear to propagate into other components and lead to eventual failure of one or more components of the system. Such a failure resulting from a lack of maintenance can also necessitate premature replacement of the entire system, which may have otherwise been prevented by relatively simple and inexpensive routine maintenance. However, objectively and accurately assessing the performance over time of a specific installation in an effort to optimize performance and longevity is a challenge.

Accordingly, there is an opportunity for an improved system, method, and device to monitor and assess performance of access systems.

### SUMMARY

A monitoring method, system, and device is designed to analyze operation data, including electric power consumption, in automatic access systems. The embodiments may analyze power consumption during operational events, the results of which may characterize auto-access system performance and wear over time.

According to embodiments, a device for detecting fault conditions of an automatic access system is provided. The device may comprise: a housing comprising a power input configured to receive electricity from a power source and a power output configured to transmit at least a portion of the electricity to an operator component of the automatic access system; an energy metering component configured to collect energy usage data associated with an operation of the operator component; and a processor interfaced with the energy metering component and configured to: analyze the energy usage data to determine an energy usage over time associated with the operation of the operator component, compare the energy usage over time to a baseline energy usage over time associated with the automatic access system, based on the comparing, determine that the energy usage over time differs from the baseline energy usage over time by at least a threshold amount, and after determining that the energy usage over time differs from the baseline energy usage over time by at least the threshold amount, avail an electronic notification via a user electronic device associated with the automatic access system.

In another embodiment, a system for detecting fault conditions of an automatic access system is provided. The system may include: a monitoring device comprising a power input, a power output, a metering component, a processor, and a transceiver, and configured to: receive, via the power input, electricity from a power source, transmit, via the power output, at least a portion of the electricity to an operator component of the automatic access system, collect, by the metering component, a set of operation data associated with a barrier component of the automatic access system, and transmit, by the processor to a server via the transceiver, the set of operation data. The system may further include the server which comprises at least one processor configured to: receive, from the monitoring device, the set of operation data, compare the set of operation data to a baseline set of operation data associated with the automatic access system, based on the comparing, determine, by the at least one processor, that at least one metric in the set of operation data differs from a corresponding metric in the baseline set of operation data by at least a threshold amount, and after determining that the at least one metric in the set of operation data differs from the corresponding metric in the baseline set of operation data by at least the threshold amount, avail an electronic notification via a user electronic device associated with the automatic access system.

Further, in an embodiment, a computer-implemented method of detecting fault conditions of an automatic access system is provided. The computer-implemented method may include: collecting, by an energy metering component, energy usage data associated with an operation of the automatic access system; analyzing, by a processor, the energy usage data to determine an energy usage over time associated with the operation of the automatic access system; comparing, by the processor, the energy usage over time to a baseline energy usage over time associated with the automatic access system; based on the comparing, determining, by the processor, that the energy usage over time differs from the baseline energy usage over time by at least a threshold amount; and after determining that the energy usage over time differs from the baseline energy usage over time by at least the threshold amount, availing an electronic notification via a user electronic device associated with the automatic access system.

### BRIEF DESCRIPTION OF THE FIGURES

FIG. 1 depicts an overview of components and entities associated with the systems and methods, in accordance with some embodiments.

FIGS. 2A and 2B illustrate isometric views of a monitoring device for an access system, in accordance with some embodiments.

FIG. 3 illustrates a diagram of a conventional auto-access system for controlling an access mechanism.

FIGS. 4A and 4B illustrate a diagram of an auto-access system, in accordance with some embodiments.

FIG. 5 is a flow diagram of an example method of detecting fault conditions of an automatic access system, in accordance with some embodiments.

FIG. 6 is a flow diagram of an example method of assessing operation of an automatic access system using machine learning, in accordance with some embodiments.

FIG. 7 is an example hardware diagram of a server configured to perform various functionalities, in accordance with some embodiments.

### DETAILED DESCRIPTION

Automatic access systems are used to provide access to indoor or outdoor spaces via a motorized barrier or mechanism such as a gate or door. Typical auto-access systems encountered in residential settings are found on garage doors and access/security gates, however it should be appreciated that additional auto-access systems are envisioned, such as turnstile systems, vehicle barrier systems, smart lock systems, automatic parking systems, and others.

The embodiments describe a monitoring device that may be positioned “inline” within the power supply path to the operator motor unit of the auto-access system. In particular, the monitoring device may include various electronic circuitry that may be configured to analyze or scrutinize electric power consumption data related to operation of the auto-access system as the electricity flows through the monitoring device to the auto-access system. This analysis encompasses various operational and idle states of the operator motor unit, whereby the monitoring device captures relevant telemetry data and summarizes event information. According to embodiments, this captured data may be processed on the monitoring device (e.g., using a local processor), where the monitoring device may additionally or alternatively transmit this data to a back-end server (i.e., the cloud) through a network connection (e.g., a WiFi connection) for comprehensive analysis and comparison to historical data. The embodiments further contemplate the training and use of a machine learning model which may supplement the data analysis.

The disclosed monitoring device introduces a significant advancement in the field of auto-access systems, in particular by incorporating electrical monitoring and assessment capabilities directly within the power supply path to the operator motor unit. This innovative approach represents a departure from conventional auto-access systems, which typically lack the ability to analyze or scrutinize electric power consumption data related to the operation of the system. By embedding various electronic circuitry within the monitoring device, it is equipped to perform detailed analysis of the electricity flowing through to the auto-access system, covering a range of operational and idle states of the operator motor unit.

One of the key improvements offered by this monitoring device is its ability to capture relevant data and summarize event information in real-time or near-real-time, or generally in association with operation of the access system. This capability enables the device to detect subtle changes in power consumption that may indicate potential issues or inefficiencies within the auto-access system. For instance, an increase in power consumption during operation could signal mechanical resistance or an impending failure of the operator motor unit, thus enabling for preemptive maintenance or adjustments to be made before a complete system failure occurs.

Furthermore, the monitoring device enhances the functionality of auto-access systems by processing the captured data either locally or transmitting it to a back-end server via a network connection, such as WiFi. This dual approach to data handling allows for immediate on-device analysis as well as comprehensive examination and comparison against remotely-stored historical data. Such a comprehensive analysis can uncover patterns or trends in power consumption that may not be apparent from a single instance of data, providing deeper insights into the performance and operational health of the system. These improvements may be further enhanced by the incorporation of machine learning features, which are configured to train a machine learning model using a training dataset of historical operation data, and analyze current operation data by the trained machine learning model.

By offering these electrical monitoring and assessment features, the monitoring device not only improves the reliability and efficiency of auto-access systems but also contributes to a more proactive maintenance strategy. This can lead to extended lifespan of the operator motor unit, reduced downtime, and potentially lower energy consumption, as the system can be optimized based on the insights gained from the monitoring device. Additionally, the embodiments generate and communicate relevant alerts and electronic communications to operators associated with the access systems, which increases attention to potential issues and ultimately reduces failure events. Overall, the present embodiments represent a significant step forward in the technology of auto-access systems, providing users with enhanced control, insight, and reliability that were not possible with conventional systems lacking such electrical monitoring capabilities.

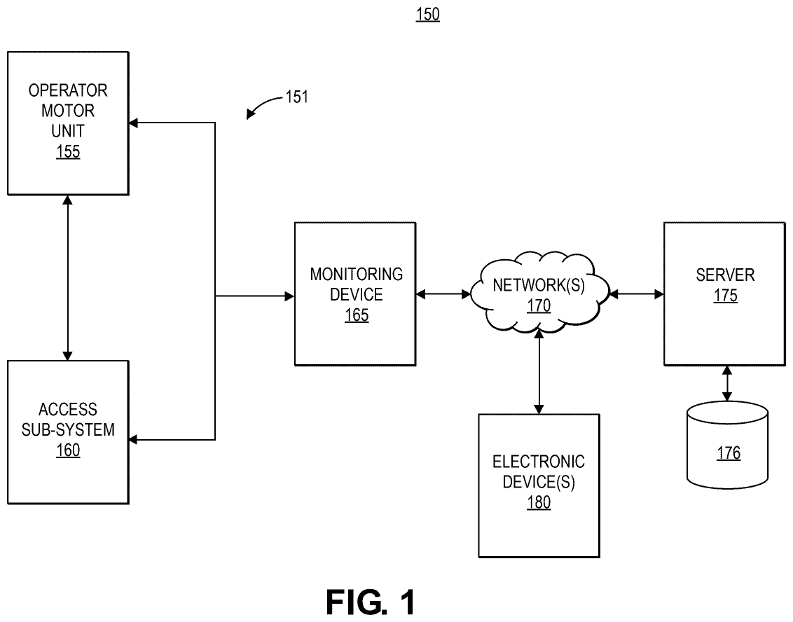

FIG. 1 illustrates an overview of a system 150 of components configured to facilitate the systems and methods. It should be appreciated that the system 150 is merely an example and that alternative or additional components are envisioned. Generally, the system 150 may be related to an auto-access system.

As illustrated in FIG. 1, the system 150 may include a set of customer components 151 that may include an operator motor unit 155 that may be communicatively connected to an access sub-system 160. Generally, the operator motor unit 155 may integrate various components to control the movement of a barrier (e.g., a garage door, security gate, access door, etc.) associated with the access sub-system 160. In particular, the operator motor unit 155 may include a power source interface, via which the operator motor unit 155 may connect to an electrical supply (typically 120V or 240V AC) and may include a transformer or power converter to adjust the voltage to suit any motor and control electronics, as well as a power control unit to ensure proper distribution of power. The operator motor unit 155 may additionally include an electric motor which may provide the force needed to move the barrier. The motor may be DC or AC-powered, and may be regulated by a motor controller that manages speed, direction, and torque.

The output of the motor may be transmitted, to the access sub-system 160, through a drive system interface, which may include a reduction gearbox or mechanical transmission to convert the high-speed rotation of the motor into the slower, higher-torque motion required to move the barrier. The operator motor unit 155 may further comprise a microcontroller or logic/control board (not shown in FIG. 1) which may be configured to govern the operation of the operator motor unit 155 by responding to inputs such as remote controls or sensors, and controlling the motor, sensors, and any safety features. It should be appreciated that the operator motor unit 155 may include other various components (not shown in FIG. 1), such as limit switches to define the fully open or closed positions of the barrier; optical sensors or proximity sensors to detect obstacles in the path of the barrier, manual overrides or emergency stop buttons for operator control in the event of a system failure; indicator lights or a display to provide feedback to the operator, signaling a status of the barrier and any system faults; communication interfaces such as a radio receiver or Bluetooth module to enable remote control, such as a key fob, mobile app, wall control pad, and/or the like.

Generally, the access sub-system 160 is configured to control a barrier, and may include several components (not shown in FIG. 1) including the barrier, tracks or guides, a drive system (e.g., a chain drive system), and various supporting elements. The barrier itself may serve as the physical gate or arm that restricts or grants access to a location, area, or the like, and may move along a defined path to either block or clear the entrance. The barrier may be supported by tracks or guides that help maintain its alignment and ensure smooth movement as it opens and closes. These tracks may be mounted along the floor or walls, and may be reinforced to withstand the weight and motion of the barrier, ensuring stability and durability over time.

The drive system, which may be configured to move the barrier, connects to the motor of the operator motor unit 155, and provides the necessary force to lift, lower, or swing the barrier. In particular, the drive system may include a drive shaft, pulleys, or a belt that connects the motor to the barrier, translating rotational motion into linear or swinging movement. The drive system may also include limit switches to define the open and closed positions of the barrier, ensuring that it stops at the appropriate points without over-traveling.

The monitoring device 165 may be configured to communicatively couple with the operator motor unit 155 and the access sub-system 160. It should be appreciated that the monitoring device 165 may be integrated inline within a power supply path to the operator motor unit 155. The monitoring device 165 may be equipped with a variety of electronic circuitry that may be configured to capture and record operation data such as energy usage data, including but not limited to voltage levels, current draw, and power quality metrics. The electronic circuitry may further enable the monitoring device 165 to perform detailed analyses of the operation data associated with the operation of the auto-access system. In particular, the monitoring device 165 may be configured to distinguish between various operational and idle states of the operator motor unit 155, thereby enabling for the capture and processing of telemetry data and the summarization of event information pertinent to system performance and efficiency, potential issues, and overall operational health. By capturing and processing data related to power consumption during different states of operation, the monitoring device 165 may identify patterns or anomalies that may indicate mechanical resistance, wear, or impending failures within the operator motor unit 155 or other components of the system 150. Additional components of the operator motor unit 155, the access sub-system 160, and the monitoring device 165 are further described with respect to the remaining figures.

The monitoring device 165 may be configured to communicate with a server 175 via one or more networks 170. The server 175 may be associated with an entity (e.g., a corporation, company, or the like) that may be configured to facilitate various of the functionalities as discussed herein. In embodiments, the server 175 may be remote (i.e., back end or cloud) from the set of customer components 151, or may be a computing device that is local to the set of customer components 151 (e.g., the server 175 may be a computer that is on-site at the residence of a customer). In embodiments, the network(s) 170 may support any type of data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others).

Generally, the monitoring device 165 may continuously measure operation data (e.g., electrical characteristics of the power consumed by components of the system 150), including capturing data during different phases of operation, such as when the system is actively opening or closing a barrier, as well as when it is in an idle state. The monitoring device 165 may process the collected data to summarize certain information, such as average power consumption, peak power usage times, and any anomalies or deviations from normal operation patterns. In addition to general energy usage data, the monitoring device 165 may capture telemetry data related to the operational state of the various components, such as the number of cycles completed, duration of operation, and any error codes or alerts generated by the various components.

The monitoring device 165 may package the collected and summarized data into a format suitable for transmission, such as by compressing the data to reduce bandwidth requirements and encrypting it to ensure security during transmission. Further, the monitoring device 165 may connect to the server 175 via the network(s) 170 and continuously or periodically transmit the collected operation data to the server 175. The frequency of transmission may be configured based on the needs of the system and the capacity of the network connection.

Upon receiving the data from the monitoring device 165, the server 175 may store it in a database 176 that may be designed to handle large volumes of operational data from multiple systems. The server 175 may employ various analytical tools to analyze the operation data. For example, the server 175 may compare the received data against historical data and known patterns of energy usage to identify any deviations or anomalies. This could include unusual energy consumption patterns, unexpected operational states, or failure to complete cycles as expected.

The server 175 may also perform a correlation analysis to determine if any detected anomalies are isolated incidents or part of a broader issue affecting the set of customer components 151. By comparing data across different times and similar systems, the server 175 may be able to identify common fault conditions. Once a potential fault condition is detected, the server 175 may use diagnostic algorithms to identify the specific nature of the fault, such as by analyzing the type of anomaly, its duration, frequency, and impact on the operation of the set of customer components 151.

It should be appreciated that the server 175 may additionally employ machine learning techniques to analyze the data. In particular, using trained machine learning models, the server 175 may analyze the operation data to predict potential issues or failures within the set of customer components 151. For example, the machine learning model may output an estimate of the remaining useful life of components, identify components at risk of failure, and suggest preventative maintenance actions. In embodiments, the server may update the machine learning model with new data received from the monitoring device 165 (and other monitoring devices), allowing the machine learning model to learn from new patterns and improve its predictive accuracy over time.

For each detected fault condition, the server 175 may generate an alert or electronic communication that may describe the nature of the fault, its potential causes, and the affected components of the set of customer components 151. The alert may also include a set of recommendations for corrective actions, such as inspections, repairs, or adjustments needed to resolve the issue. In embodiments, the server 175 may prioritize alerts based on the severity and urgency of the fault condition (e.g., by prioritizing critical faults that pose immediate safety risks or could lead to significant system damage).

The server 175 may customize the alerts based on the preferences and roles of any individual(s) associated with the set of customer components 151. For instance, technical details and repair instructions might be directed to maintenance personnel, while system owners might receive simplified alerts focusing on implications and recommended actions.

The server 175 may identify, for example based on a configuration or user profile(s) stored in association with the set of customer components 151, any electronic device(s) 180 or accounts (e.g., email accounts) of individuals associated with the set of customer components 151, such as a system owner, operator, and/or maintenance personnel. The server 175 may transmit any alerts to the identified electronic device(s) 180 via the network(s) 170, and according to different communication channels such as email, SMS, push notifications through mobile apps, automated voice calls, and/or the like, which may depend on any preferences set by the recipients.

A recipient(s) of an alert may use the electronic device(s) 180 to acknowledge the alert and provide feedback through the same communication channels. The server 175 may record this feedback, including actions taken in response to the alert, such as to refine future alerts and improve the overall monitoring and maintenance features.

Although a single set of customer components 151 comprising the monitoring device 165, the operator motor unit 155, and the access sub-system 160 is depicted and described with respect to FIG. 1, it should be appreciated that the server 175 may interface with multiple sets of customer components that comprise similar components or devices. Similarly, although depicted as a single server computer 175 in FIG. 1, it should be appreciated that the server 175 may be in the form of a distributed cluster of computers, servers, machines, cloud-based services, or the like. In this implementation, the distributed server(s) 175 may be utilized as part of an on- demand cloud computing platform. Accordingly, when the monitoring device 165 and the electronic device(s) 180 interface with the server 175, the monitoring device 165 and the electronic device(s) 180 may actually interface with one or more of a number of distributed computers, servers, machines, or the like, to facilitate the described functionalities. It should further be appreciated that the monitoring device 165 may additionally or alternatively perform the various data processing functionalities as described as being performed by the server 175.

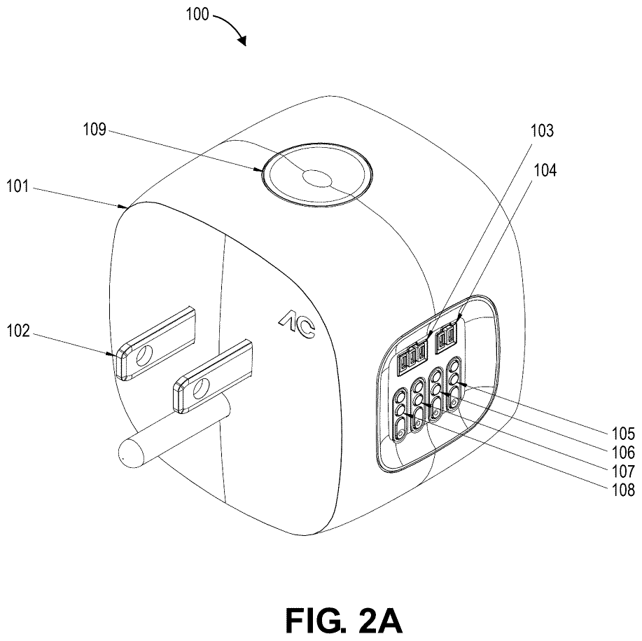

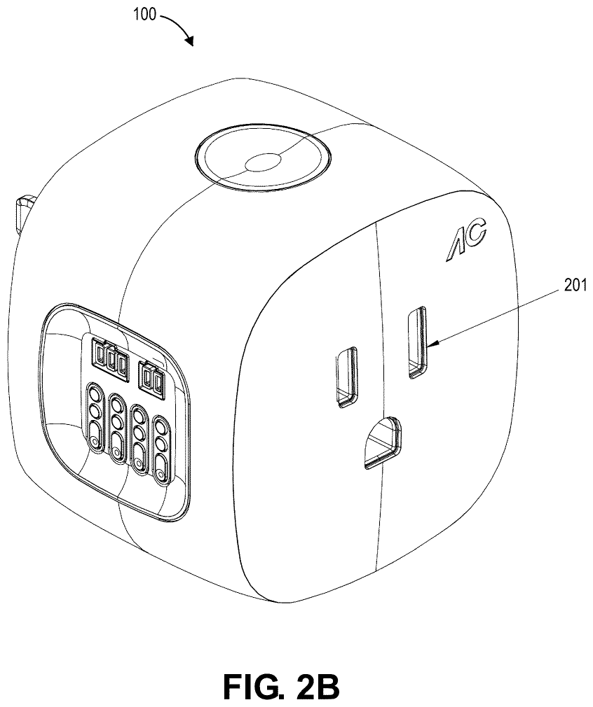

FIGS. 2A and 2B illustrate isometric views of a monitoring device 100 for an access system, according to embodiments. While the embodiments as described herein relate to monitoring certain conventional access components (e.g., a residential sectional garage door with a torsion spring counterbalance system), it should be appreciated that the techniques and equipment described herein can be applied to any automatic access system for monitoring performance and degradation of that system over time. Further, it should be appreciated that the monitoring device 100 may include additional or alternative components, as well as alternative configurations of the components.

As illustrated in FIGS. 2A and 2B, the monitoring device 100 may include a device housing 101, a power input 102, a power output 201, two accessory inputs 103, 104, pass-through connectors for wall control pad wiring 105, 106, pass-through connectors for infrared sensor wiring 107, 108, and a button or selector 109. The power input 102 may be a NEMA 5-15P plug and the power output 201 may be a NEMA 5-15R receptacle, which may offer compactness and ease of user connection. It should be appreciated that the foregoing is merely an example and that there are other ways of connecting the monitoring a power supply for an auto-access system.

A user, such as a homeowner, resident, or service technician, may connect the power input 102 to an outlet designated as the power source for the operator control unit (not shown in FIG. 1 or 2). The user may additionally connect a power cable (not shown) from the operator control unit to the power output 201 of the monitoring device. Such a connection may provide the primary power source to the monitoring device and to the operator motor unit.

A set of wall control pad connectors may offer an optional provision for inline or alternative connection with a signal wire, therefore enabling remote triggering of a switch (e.g., via an internet command) to create open/close events. Similarly, a set of infrared (IR) sensor connectors may provide an optional provision for inline connection with the signal wire, which may furnish specific information to the monitoring system upon sensor activation, such as when an obstruction is present that may interfere or collide with the access mechanism or barrier during a “close” event. The button or selector 109 may enable a manual relay of open/close commands and facilitate additional device actions, such as resetting or mode changes, through varied button interactions.

According to embodiments, an embedded system may be enclosed within the housing 101, where the embedded system may include a set of components such as, for example, a microcontroller, an energy consumption monitoring device, a relay or switching device, and wireless transceiver(s) for local and/or remote communication, such as with a WiFi router or wireless non-contact switches, wireless speed sensors, etc. The energy consumption monitoring device may gauge the voltage and current of the load connected to the main power output, and store multiple readings for local (i.e., on-device) analysis or upload to a back-end server (i.e., cloud) for initial or additional analyses.

The relay or switching circuitry, such as that associated with a wall control pad input and output, may enable remote triggering of open/close events via remote (e.g., internet) commands. Wireless transceivers, which may be provisioned through a mobile application or standard network security protocols (e.g., “push button” Wireless Protected Setup (WPS)), may facilitate communication with a wireless network. Data transmission across the wireless link may adhere to standard protocols like HTTP(S) or MQTT, thus ensuring seamless upload of collected data to the back-end (cloud) service.

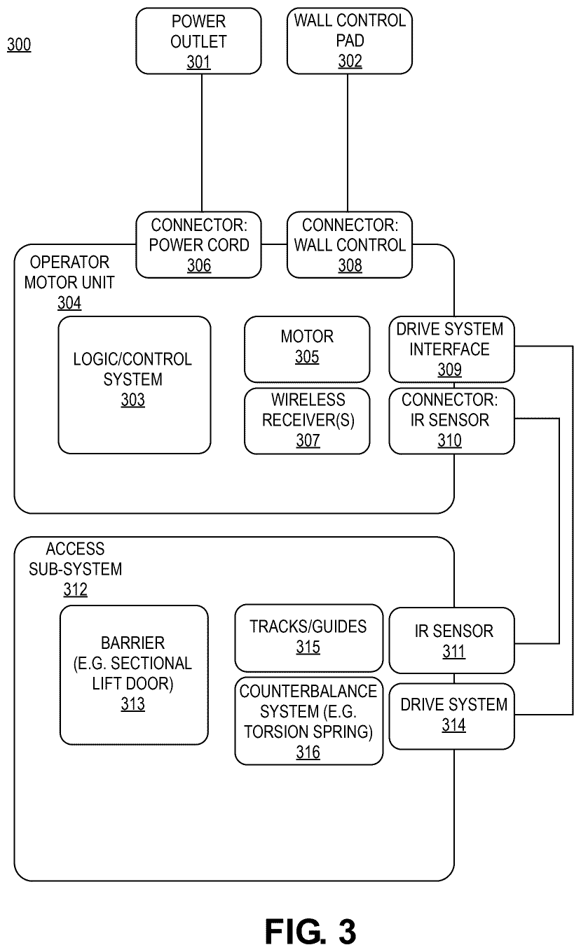

FIG. 3 illustrates a diagram of a conventional auto-access system 300 for controlling an access mechanism (e.g., a garage door). As illustrated in FIG. 3, the system 300 may include a power outlet 301 which is the source of electrical power for the system 300, therefore supplying electricity to the various other components. Additionally, a wall control pad 302 may be mounted on a wall and include a user interface for manual control, such as buttons or keys to open or close the access mechanism. When a user presses a button or specific combination of buttons, the wall control pad 302 may send a signal to a logic/control system 303.

The system may include an operator motor unit 304 which may house a motor 305 that may be configured to move/lift the access mechanism. Generally, the operator motor unit 304 may receive commands from the logic/control system 303. A power cord connector may be a cable that connects the operator motor unit 304 to the power outlet 301, ensuring that the motor 305 receives electricity. The wall control pad 302 may be connected to the operator motor unit 304 via a wall control connector 308.

Generally, the logic/control system 303 may be configured to manage various components of the system 300. In particular, the logic/control system 303 may receive a set of signals from various sensors and devices, process the set of signals, and control the motor 305 accordingly.

A set of wireless receivers 307 may be configured to receive a set of wireless signals from remote controls or other wireless devices used to remotely operate the system 300. For example, when a user presses a remote button to open the access mechanism, the wireless receiver 307 detects the signal and relays it to the logic/control system 303. It should be appreciated that the set of wireless receivers 307 may be any type of network interface hardware capable of supporting any type of wired or wireless wide area network (WAN), local area network (LAN), personal area network (PAN), or low-power wide area network (LPWAN). For example, the set of wireless receivers 307 may support any WiFi, Ethernet, Internet, Matter, Zigbee, Z-Wave, cellular, GPS, RFID, NFC, Infrared, satellite, powerline, Bluetooth, etc.

A drive system interface 309 facilitates communication between the logic/control system 303 and the motor 305. When the logic/control system 303 determines to open or close the access mechanism, the logic/control system 303 sends commands through the drive system interface 309.

Generally, a set of infrared sensors 311 of an access sub-system 312 may detect obstacles in the path of the access mechanism. If an obstacle is detected, the IR sensor 311 communicates with the logic/control system 303 to prevent the access mechanism from closing on the obstacle(s).

The access sub-system 312 may include various additional features or components. In particular, a barrier 313 may be a lift door or other access mechanism that may be moved by a drive system 314. Additionally, a set of tracks/guides 315 and a counterbalance system (e.g., torsion spring) 316 may be a set of mechanical parts that guide the movement of the access mechanism and balance its weight during operation. The set of tracks 315 may ensure smooth motion, while the counterbalance system 316 may help manage the weight of the access mechanism.

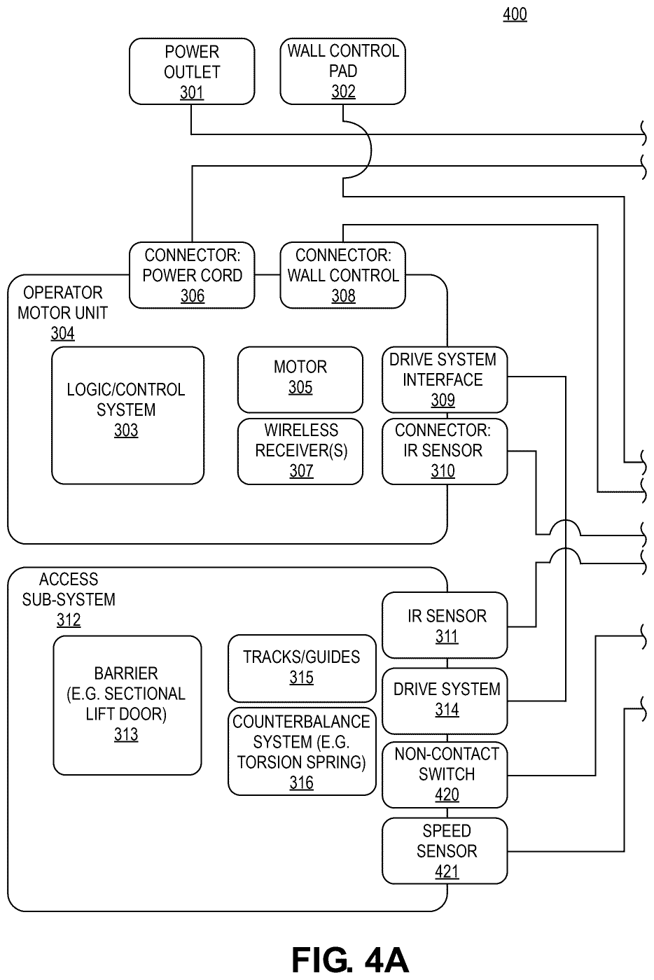

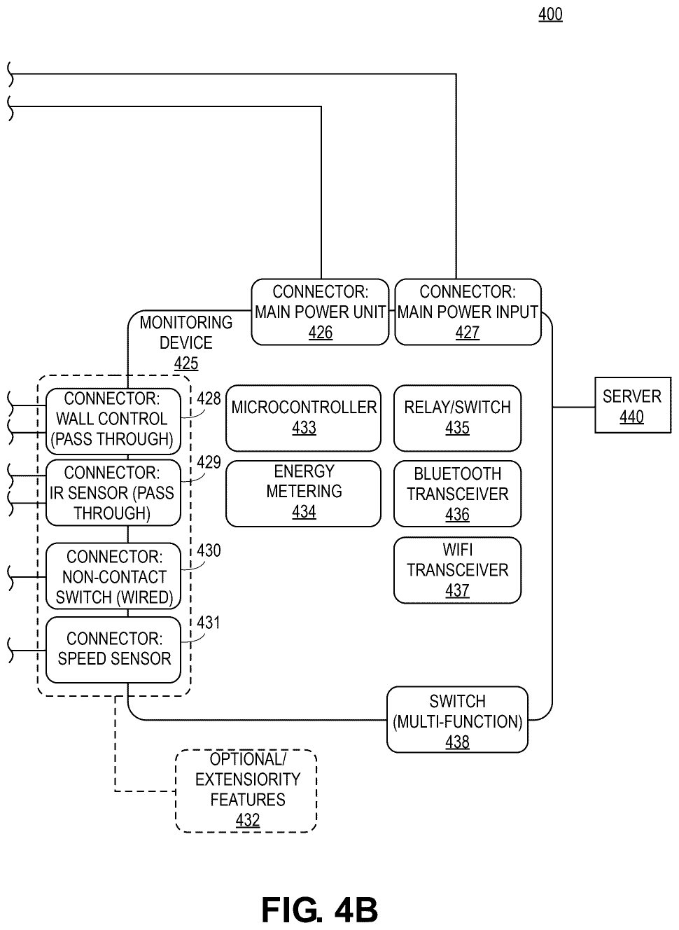

FIGS. 4A and 4B illustrates a system 400 according to the present embodiments, where the system 400 includes a portion of the same or similar components as the system 300 of FIG. 3, and includes a set of additional components.

As illustrated in FIGS. 4A and 4B, the system 400 may include a monitoring device 425 that may be configured with various components that facilitate the described functionalities. In particular, the monitoring device 425 may be configured with a main power input connector 427 that connects to the power outlet 301. Similarly, the monitoring device 425 may include a main power output connector 426 via which at least a portion of the electricity from the power outlet 301 powers the operator motor unit 304 via the power cord connector 306.

The monitoring device 425 may further be configured with an additional set of connectors. In particular, a pass-through wall control connector 428 may transmit signals from the wall control pad 302 to the operator motor unit 304 via the wall control connector 308; a pass-through IR sensor connector 429 may transmit signals from the IR sensor 311 to the operator motor unit 304 via the IR sensor connector 310; a non-contact switch connector 430 may receive signals from a non-contact switch 420 (e.g., a proximity switch) of the access sub-system 312; and a speed sensor connector 431 may receive signals from a speed sensor 421 of the access sub-system 312. It should be appreciated that a set of optional/extensibility features 432 is envisioned.

The monitoring device 425 may additionally be configured with a relay switch 435 to enable a low-power signal to control a higher-power circuit or device (i.e., the operator motor unit 304), as well as a multi-function switch 438 that may be configured to control operation of the access mechanism, one or more lights, a locking mechanism, a set of safety sensors, and/or other components.

The monitoring device 425 may further be configured with additional components or modules associated with the described embodiments. In particular, a microcontroller 433 (or more generally, a processor or controller) may be configured to access data generated by any of the sensors or components of the system 400, analyze this data, and determine an action(s), recommendation(s), etc. to undertake based on the analysis, and facilitate this action(s).

Further, an energy metering component 434 may be configured to interface with the microcontroller 433 to measure and monitor the energy consumption associated with operating the access mechanism, thereby enabling the tracking of energy consumption and identification of patterns. In particular, the energy metering component 434 may measure operating data, including the amount of electrical energy consumed by the access mechanism, and any related components, during its operation, and may track parameters such as voltage, current, power factor, and energy usage over time. The energy metering component 434 may collect this data, enable access to the data by the microcontroller 433, and/or locally store this data, such as in a local memory (not shown in FIGS. 4A or 4B). Additionally or alternatively, the microcontroller 433 may transmit this data to a server 440 via one or more network connections, for example via a WiFi transceiver 437. The monitoring device 425 may also be configured with a Bluetooth or other personal area network (PAN) transceiver 436 for communicating with additional devices. It should be appreciated that other types of transceivers that enable local or remote communication are envisioned.

Generally, by receiving and analyzing data from the energy metering component 434, the microcontroller 433 may assess and analyze energy usage patterns, identify peak usage times, and assess overall energy efficiency. In particular, the microcontroller 433 may chart power usage over time in association with operating the access mechanism, and create a power usage profile that illustrates how energy consumption varies over time. As the access mechanism and related components operate, the energy metering component 434 may record the amount of electrical power being consumed in real-time, and log this data at regular intervals, such as every second, to capture the power usage profile with sufficient detail. The microcontroller 433 may analyze the recorded power consumption data and plot it over time to illustrate how power usage varies throughout operation. For example, an x-axis of the plot represents time, while the y-axis represents power consumption in watts or kilowatts.

According to embodiments, the microcontroller 433 may establish or access one or more baseline energy usage profiles associated with operation of the access mechanism, where this baseline energy usage profile(s) may represent an average or expected power consumption by system components over a cycle of operation (e.g., an opening or closing of a garage door). In particular, the microcontroller 433 may establish the baseline energy usage profile(s) based on a series of operations of the system. Alternatively or additionally, a given baseline energy usage profile may be associated with a specific make or model of the system (e.g., a specific make/model of a garage door opener).

For each instance of the access mechanism being operated (e.g., opened or closed), the microcontroller 433 may access and analyze data from the energy metering component 434 to assess an energy usage for that instance, where the energy usage may be a plot of the power consumption of the system components over time. Further, the microcontroller 433 may compare the energy usage for that instance to the baseline energy usage profile to assess any deviation or difference. It should be appreciated that the microcontroller 433 may compare the energy usage to a specific baseline energy usage profile based on the type of operation. For example, if the energy usage corresponds to a garage door opening, that energy usage may be compared to a baseline energy usage profile associated with a garage door opening; and if the energy usage corresponds to a garage door closing, that energy usage may be compared to a baseline energy usage profile associated with a garage door closing.

According to embodiments, the microcontroller 433 may determine whether an energy usage for a particular operation instance deviates or differs from the baseline energy usage profile by at least a threshold amount. In particular, the microcontroller 433 may ensure that both power usage profiles are normalized to the same scale and time intervals for accurate comparison, including aligning the time intervals and ensuring that the units of measurement (e.g., watts or kilowatts) are consistent. Further, the microcontroller 433 may calculate the difference between the corresponding data points of the two power usage profiles at each of multiple time intervals, resulting in a series of difference values representing the discrepancy between the two profiles at each point in time.

The microcontroller 433 may further access or determine the threshold amount by which the power usage profiles may be considered sufficiently discrepant, where this threshold could be a fixed value or a percentage of the maximum power usage observed in either profile, and where this threshold could be default or configurable by a user. Additionally, the microcontroller 433 may examine the calculated differences and compare them to the threshold amount. If the absolute difference at any time interval exceeds the threshold, the microcontroller 433 may consider the two profiles to be different at that point in time. Alternatively or additionally, the microcontroller 433 may aggregate the results of the comparison to determine if the overall difference between the two power usage profiles exceeds the threshold amount, where the overall difference may be embodied as the maximum difference, the average difference, or the total difference over the entire duration of the profiles.

If the energy usage for a particular instance of operation deviates or differs from the baseline energy usage profile by at least the threshold amount, the microcontroller 433 may facilitate certain functionalities. In embodiments, the microcontroller 433 may determine that the operation deviates or differs from the baseline energy profile when multiple energy usage profiles differ from a corresponding baseline energy usage profile. For example, these functionalities may be triggered when the microcontroller 433 determines that five (5) consecutive energy usage profile instances differ from the baseline energy usage profile by at least the threshold amount; or when nine (9) of the last ten (10) energy usage profile instances differ from the baseline usage profile by at least the threshold amount.

Generally, the comparison of energy usage data to a baseline energy usage profile may account for certain aberrant power qualities that fall outside predefined boundary conditions. In particular, the microcontroller 433 may monitor various power quality parameters, such as voltage levels, current fluctuations, harmonic distortions, power factor, and/or the like, and comparing this parameter(s) against established boundary conditions that represent normal operation. When a power quality parameter deviates from an applicable boundary conditions (e.g., by a threshold amount), it may indicate the presence of a current or impending fault condition within the system. For instance, a sudden drop in voltage level or an unexpected increase in harmonic distortion could signal an electrical fault or a malfunctioning component within the system. A specific boundary condition and threshold may be set for each power quality parameter, and the microcontroller 433 may be configured to automatically detect when any parameter exceeds its boundary condition by the specific threshold, suggesting an aberrant condition that requires further investigation. It should be appreciated that the microcontroller 433 may facilitate certain functionalities in response to additional triggers, such as an electrical outage or the receipt of incomplete data.

According to embodiments, the microcontroller 433 may interface with the server 440 to notify the server 440 of an instance of the energy usage deviating from the baseline energy usage profile. The server 440 may generate a notification that indicates the energy usage deviation, and may cause the notification to be communicated to an account or device associated with a user (e.g., a resident of a property associated with the automatic access system). The notification may further indicate various information regarding the energy usage deviation, including a recommendation to have the access mechanism serviced, some information about why a servicing is needed and potential risks associated with not having a servicing performed, and/or other information. In this regard, the user is notified of a potential fault or breakdown risk associated with the access mechanism. By servicing or having the access mechanism or any of its components serviced, the user may fix any underlying issue with the access mechanism or other component(s), instead of a complete breakdown of the access mechanism or other component(s) occurring due to not servicing the access mechanism or other component(s). Ultimately, this extends the life of the access mechanism or other component(s) and saves the user money.

While the embodiments describe the microcontroller 433 analyzing the collected data and facilitating various functionalities, it should be appreciated that the microcontroller 433 may transmit, via the WiFi transceiver 437 or another transceiver, the collected data to the server 440, where the server 440 may additionally or alternatively analyze the collected data and facilitate the various functionalities. The microcontroller 433 and/or the server 440 may compare any collected or analyzed data to historical data, to assess discrepancies and to determine whether any fault conditions exist.

Additionally, while the embodiments describe the microcontroller 433 collecting and analyzing data associated with operation of components of the system 400 (e.g., the operator motor unit 304), it should be appreciated that the microcontroller 433 may alternatively or additionally collect and analyze data when the components of the system 400 are idle (e.g., when an access mechanism is not being actuated). Any data collected during this idle state may enable the monitoring device 425 to gain additional insight into potential fault conditions associated with the system 400.

It should be appreciated that the embodiments may employ various artificial intelligence and machine learning aspects. In particular, the embodiments may train and utilize a machine learning model that may be configured to analyze energy usage data and output information indicative of the operation of the automatic access system. It should be appreciated that the machine learning functionalities may be facilitated locally on the monitoring device 425 and/or remotely by the server 440.

According to embodiments, the machine learning model may be trained on a dataset that includes operating data histories and failure statistics or conditions for a plurality of automatic access systems and components thereof (e.g., a barrier or access mechanism), such as those across different residential and/or commercial settings over various periods of time. This training data may include both access system components that operated throughout their expected lifetime (i.e., positive examples) as well as access system components that failed prematurely (i.e., negative examples). For each access system component included in the training data, the operating data history may include energy usage data embodied as any combination of the following: electrical characteristics (e.g., voltage levels, current levels, power quality metrics), environmental parameters (e.g., temperature, humidity, vibration/shock levels), duty cycle information (e.g., number of hours operational per day/week/month and cycling frequencies), manufacturing data (e.g., make and model information, factory sources), failure mode information (e.g., descriptions of how and when components stopped operating or otherwise experienced fault conditions).

This training data may be used to train a machine learning model. According to embodiments, this functionality may leverage various machine learning and deep learning techniques such as artificial neural networks, random forests, gradient boosting machines, or other supervised and unsupervised learning algorithms suitable for processing the mixture of structured data (e.g., electrical characteristics) and unstructured data (e.g., failure descriptions) present in the training set. Generally, the training objective is to have the machine learning model learn the mapping between the operating data patterns and the observed failure/non-failure outcomes in the training data, thus enabling trained machine learning model to then take operating data (e.g., energy usage data) for a subject access system component (e.g., a garage door opener) as input and generate predictive outputs about its likelihood of failure in the future.

In particular, the machine learning model may be deployed to monitor access system installations/components that may not have been part of the original training data (e.g., the system 400). For a particular access system component, operating data for that component may be collected, where the operating data may include the same or similar types of electrical, environmental, duty cycle, and/or manufacturing information as was present in the training data. This operating data may be input into the trained machine learning model, which may analyze the operating data and output certain data. In particular, the output data may include an estimated remaining useful life that may indicate an estimated amount of time remaining before the access system component will suffer a fault condition based on its operating data pattern, and/or a probability(ies) over various future time horizons that the access system component will experience a failure condition requiring replacement.

Additionally or alternatively, the output data may identify a particular component or device (e.g., motor, spring, rollers, guide tracks) of the access system component that may be faulty, based on an operating data pattern. This may enable certain repairs and preventative actions to avoid any disruptions and safety issues of unexpected outages or failures. Any repair or replacement events may be recorded and embodied as additional data (i.e., additional training data) that may be used to continuously train the machine learning model, which may result in the identification of additional edge cases and to generally improve operation and accuracy of the machine learning model. For example, data may identify a particular access system component and its initial output resulting from the machine learning model analysis, as well as a repair or replacement that the particular access system component underwent, where this data may be re-input into the machine learning model to additionally train the machine learning model.

It should be appreciated that the machine learning functionalities may be facilitated locally on the monitoring device 425 and/or remotely by the server 440. Additionally, as the amount of operating data from multiple auto-access systems installed in the field increases, the machine learning model may enable for a more detailed understanding of certain pervasive and/or previously unseen characteristics, issues, or failure conditions related to specific makes and models of the equipment being monitored.

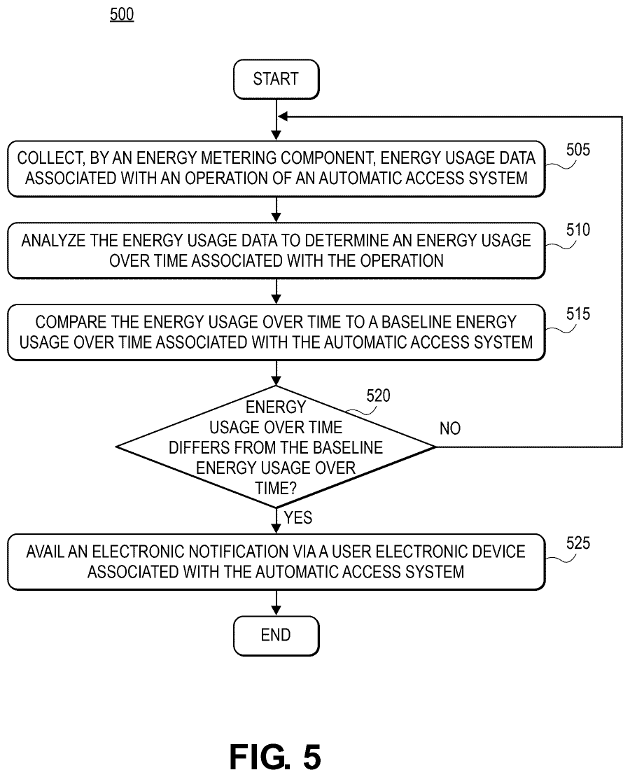

FIG. 5 is a flow diagram of an example method 500 of detecting fault conditions of an automatic access system. Although the method 500 is described as being facilitated by an electronic device such as the monitoring device 165 as described with respect to FIG. 1, it should be appreciated that one or more steps may be alternatively performed by another electronic device such as the server 175 as described with respect to FIG. 1.

The method 500 may begin at block 505 when the electronic device collects, by an energy metering component, energy usage data associated with an operation of an automatic access system. In embodiments, the energy usage data may be associated with the operation of an access mechanism of the automatic access system.

The electronic device may analyze (block 510) the energy usage data to determine an energy usage over time associated with the operation of the automatic access system. Further, the electronic device may compare (block 515) the energy usage over time to a baseline energy usage over time associated with the automatic access system. In embodiments, the electronic device may identify the baseline energy usage over time based on a type of the operation of the automatic access system, and compare the energy usage over time to the baseline energy usage over time. Alternatively or additionally, the electronic device may calculate, at multiple points in time, multiple differences between the energy usage over time and the baseline energy usage over time. In embodiments in which a processor is remote from the energy metering component (e.g., at a server), the processor may receive, from the energy metering component, the energy usage data, and analyze the energy usage data to determine the energy usage over time associated with the operation of the automatic access system.

The electronic device may, based on the comparing, determine (block 520) whether the energy usage over time differs from the baseline energy usage over time by at least a threshold amount. In embodiments, the electronic device may calculate, based on the multiple differences, an overall difference between the energy usage over time and the baseline energy usage over time, and determine that the overall difference at least meets the threshold amount. If the energy usage over time does not differ from the baseline energy usage over time by at least the threshold amount (“NO”), processing may return to block 505, end, or proceed to another functionality.

If the energy usage over time does differ from the baseline energy usage over time by at least the threshold amount (“YES”), the electronic device may avail (block 525) an electronic notification via a user electronic device associated with the automatic access system. In embodiments, the electronic device may generate the electronic notification to identify a potential fault condition associated with the automatic access system, and transmit the electronic notification to the user electronic device.

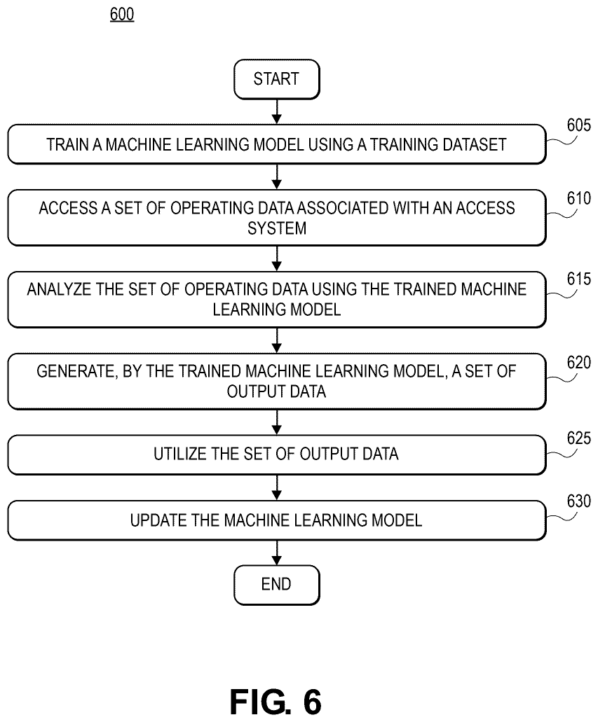

FIG. 6 a flow diagram of an example method 600 of assessing operation of an automatic access system using machine learning. The method 600 may be facilitated by one or more electronic devices (such as the monitoring device 165 and/or the server 175 as described with respect to FIG. 1).

The method 600 may begin when the electronic device trains (block 605) a machine learning model using a training dataset. According to embodiments, the training dataset may be a comprehensive dataset that includes operating data histories and failure statistics for a wide range of auto-access systems and their components. This training dataset may encompass operation data from a set of access systems that have operated successfully throughout their expected lifetimes and another set of access systems that have failed prematurely. The operating data history may include a variety of information, such as electrical characteristics (e.g., voltage levels, current levels, power quality metrics, etc.) during different operation states (e.g., opening closing, idle, etc.).

For example, a dataset may contain records of normal current draw ranges for a functioning system and elevated current draw levels that were observed before failures. Additionally or alternatively, the operation data may include data on the environment where the access systems are installed, such as temperature, humidity, and exposure to elements (e.g., systems operating in high humidity environments might show different failure modes compared to those in dry environments); information on how frequently the system is used, including the number of operations per day/week/month and cycling frequencies (e.g., systems with higher usage rates might exhibit wear-and-tear failures more quickly); details about the make and model of the system, including factory sources, which can help identify if certain models are more prone to specific types of failures; descriptions of how and when components stopped operating or experienced fault conditions, including specific parts that failed (e.g., motor burnout, spring failure) and the circumstances surrounding these failures; and/or other data.

This electronic device may train the machine learning model with this training dataset using one or more different algorithms and/or structures such as artificial neural networks, random forests, or gradient boosting machines, where the goal of the training functionalities is to enable the machine learning model to learn the correlation between specific operating patterns and the likelihood of failure.

In particular, the electronic device may perform one or more data preprocessing steps in which the raw data is cleaned and normalized to ensure consistency (e.g., converting textual descriptions of failure modes into categorical data or normalizing numerical values to a standard scale). Further, the electronic device may perform one or more feature selection functionalities to identify which data points are most relevant to predicting failures, such as by analyzing the correlation between specific electrical characteristics and failure rates or determining which environmental parameters most significantly impact system longevity. Additionally, the electronic device may undertake model selection by selecting the appropriate machine learning algorithm(s) to use. In embodiments, given the mixed nature of the data (both structured and unstructured), a combination of algorithms might be employed, such as artificial neural networks for pattern recognition in numerical data and natural language processing techniques for analyzing textual failure descriptions. The electronic device may then train the selected model using the prepared dataset, such as by feeding the model the input data (e.g., electrical characteristics, environmental parameters) and the expected output (e.g., system failure or no failure). The model may learn by adjusting its internal parameters to minimize the difference between its predictions and the actual outcomes in the training data. The electronic device may validate and test the trained model using a separate portion of the training dataset not used during the training phase, thereby assessing the accuracy of the model and its ability to generalize its predictions to new, unseen data.

At block 610, the electronic device may access a set of operating data associated with an access system. In embodiments, the set of operating data may be accessed from a monitoring device (e.g., the monitoring device 165 as described with respect to FIG. 1) that may be communicatively coupled to the access system. The electronic device may access the set of operating data in real-time or near-real-time as the monitoring device collects the set of operating data, or may periodically retrieve (or receive) the set of operating data from the monitoring device. In embodiments, the set of operating data may be real-time or near-real-time operating data associated with the access system. This set of operating data may include one or more of the same types of information that is included in the training data, including electrical, environmental, and/or duty cycle information, and/or other types of data.

The electronic device may analyze (block 615) the set of operating data using the trained machine learning model. In particular, utilizing the patterns it learned during training, the machine learning model may analyze the set of operating data, for example concurrently with the electronic device accessing the set of operating data, or after the electronic device has accumulated the set of operating data.

As a result of analyzing the set of operating data, the trained machine learning model may generate (block 620) a set of output data. According to embodiments, the set of output data may include an estimated remaining useful life of the access system and/or of its components. That is, a given estimated remaining useful life for a given component may indicate how much time is estimated to be left before a fault condition occurs to that component. Additionally or alternatively, the set of output data may include a set of probabilities of failure over various future time horizons, for the system as a whole or for one or more of its components. Additionally or alternatively, the set of output data may include information about how to address a certain component(s) of the system to prevent a future fault condition. For example, the set of output data may include information advising for the tracks/guides of the access sub-system to be fixed or replaced.

The electronic device may utilize (block 625) the set of output data in a variety of ways. For instance, if the set of output data indicates that a particular component is likely to fail, the electronic device may facilitate preemptive maintenance or replacement, thereby avoiding unexpected outages and enhancing safety. This proactive approach to maintenance not only may extend the lifespan of the auto-access system but also optimizes its operational efficiency. For further instance, the electronic device may generate an electronic communication that may summarize aspects of the set of output data, and transmit the electronic communication to an electronic device associated with an operator or owner of the automatic access system.

The electronic device may update (block 630) the machine learning model. According to embodiments, as repair or replacement events occur, the electronic device may feed, into the machine learning model, any data resulting from these events, including the initial predictions outputted by the machine learning model and any actions taken, where the electronic device may use this data as additional training data to retrain the machine learning model. These functionalities enable the machine learning model to refine its predictions, identify new patterns, and improve its overall accuracy and reliability.

Generally, these functionalities enable a transformative approach to managing the health and efficiency of auto-access systems, and enables a shift from reactive to predictive maintenance strategies, significantly enhancing the performance and reliability of these systems.

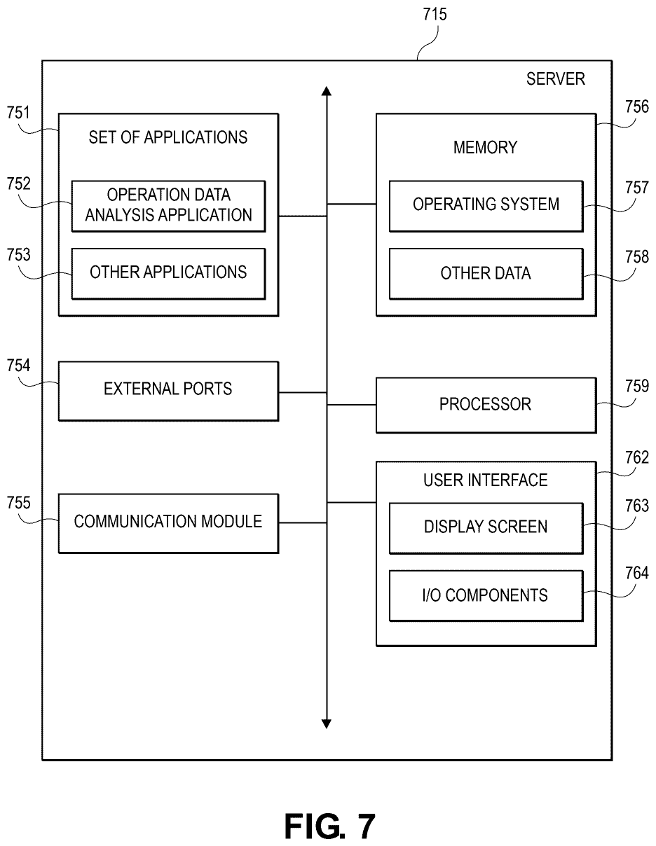

FIG. 7 illustrates a hardware diagram of an example server 715 (e.g., the server computer 175 as described with respect to FIG. 1), in which the functionalities as discussed herein may be implemented. It should be appreciated that the components of the server 715 are merely exemplary, and that additional or alternative components and arrangements thereof are envisioned.

The server 715 may include a processor 759 as well as a memory 756. The memory 756 may store an operating system 757 capable of facilitating the functionalities as discussed herein as well as a set of applications 751 (i.e., machine readable instructions). For example, one of the set of applications 751 may be an operation data analysis application 752, such as analyze operation data related to an auto-access system. It should be appreciated that one or more other applications 753 are envisioned.

The processor 759 may interface with the memory 756 to execute the operating system 757 and the set of applications 751. According to some embodiments, the memory 756 may also store other data 758, such as machine learning model data that may be used in the analyses and determinations as discussed herein. The memory 756 may include one or more forms of volatile and/or nonvolatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The server 715 may further include a communication module 755 configured to communicate data via the one or more networks (not shown in FIG. 7). According to some embodiments, the communication module 755 may include one or more transceivers (e.g., WAN, WWAN, WLAN, and/or WPAN transceivers) functioning in accordance with IEEE standards, 3GPP standards, or other standards, and configured to receive and transmit data via one or more external ports 754.

The server 715 may further include a user interface 762 configured to present information to a user and/or receive inputs from the user. As shown in FIG. 7, the user interface 762 may include a display screen 763 and I/O components 764 (e.g., ports, capacitive or resistive touch sensitive input panels, keys, buttons, lights, LEDs, external or built in keyboard). According to some embodiments, the user may access the server 715 via the user interface 762 to review information, make selections, and/or perform other functions.

In some embodiments, the server 715 may perform the functionalities as discussed herein as part of a “cloud” network or may otherwise communicate with other hardware or software components within the cloud to send, retrieve, or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 759 (e.g., working in connection with the operating system 757) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML). In some embodiments, the computer program product may be part of a cloud network of resources.

Although the preceding and following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical.

What is claimed is:

1. A device for detecting fault conditions of an automatic access system, comprising:
a housing comprising a power input configured to receive electricity from a power source and a power output configured to transmit at least a portion of the electricity to an operator component of the automatic access system;
an energy metering component configured to collect energy usage data associated with an operation of the operator component; and
a processor interfaced with the energy metering component and configured to:
analyze the energy usage data to determine an energy usage over time associated with the operation of the operator component,
compare the energy usage over time to a baseline energy usage over time associated with the automatic access system,
based on the comparing, determine that the energy usage over time differs from the baseline energy usage over time by at least a threshold amount, and
after determining that the energy usage over time differs from the baseline energy usage over time by at least the threshold amount, avail an electronic notification via a user electronic device associated with the automatic access system.

2. The device of claim 1, wherein the operator component is an access mechanism of the automatic access system.

3. The device of claim 1, wherein to compare the energy usage over time to the baseline energy usage over time, the processor is configured to:
identify the baseline energy usage over time based on a type of the operation of the automatic access system, and
compare the energy usage over time to the baseline energy usage over time.

4. The device of claim 1, wherein to compare the energy usage over time to the baseline energy usage over time, the processor is configured to:
calculate, at multiple points in time, multiple differences between the energy usage over time and the baseline energy usage over time.

5. The device of claim 4, wherein to determine that the energy usage over time differs from the baseline energy usage over time by at least the threshold amount, the processor is configured to:
calculate, based on the multiple differences, an overall difference between the energy usage over time and the baseline energy usage over time, and
determine that the overall difference at least meets the threshold amount.

6. The device of claim 1, wherein to avail the electronic notification, the processor is configured to:
generate the electronic notification to identify a potential fault condition associated with the automatic access system, and
transmit the electronic notification to the user electronic device.

7. A system for detecting fault conditions of an automatic access system, the system comprising:
a monitoring device comprising a power input, a power output, a metering component, a processor, and a transceiver, and configured to:
receive, via the power input, electricity from a power source,
transmit, via the power output, at least a portion of the electricity to an operator component of the automatic access system,
collect, by the metering component, a set of operation data associated with a barrier component of the automatic access system, and
transmit, by the processor to a server via the transceiver, the set of operation data; and
the server comprising at least one processor configured to:
receive, from the monitoring device, the set of operation data,
compare the set of operation data to a baseline set of operation data associated with the automatic access system,
based on the comparing, determine, by the at least one processor, that at least one metric in the set of operation data differs from a corresponding metric in the baseline set of operation data by at least a threshold amount, and
after determining that the at least one metric in the set of operation data differs from the corresponding metric in the baseline set of operation data by at least the threshold amount, avail an electronic notification via a user electronic device associated with the automatic access system.

8. The system of claim 7, wherein to collect the set of operation data, the monitoring device is configured to:
collect, by the metering component, energy usage data associated with the barrier component of the automatic access system.

9. The system of claim 7, wherein to compare the set of operation data to the baseline set of operation data, the at least one processor of the server is configured to:
identify the baseline set of operation data based on a type of operation of the automatic access system, and
compare the set of operation data to the baseline set of operation data.

10. The system of claim 7, wherein to compare the set of operation data to the baseline set of operation data, the at least one processor of the server is configured to:
calculate, at multiple points in time, multiple differences between the set of operation data and the baseline set of operation data.

11. The system of claim 7, wherein the at least one processor of the server is further configured to:
train a machine learning model using a training dataset comprising at least the baseline set of operation data.

12. The system of claim 11, wherein to compare the set of operation data to the baseline set of operation data, the at least one processor of the server is configured to:
analyze, using the machine learning model that was trained, the set of operation data.

13. The system of claim 12, wherein to determine that the at least one metric in the set of operation data differs from the corresponding metric in the baseline set of operation data by at least the threshold amount, the at least one processor of the server is configured to:
output, by the machine learning model that was trained, an indication of a predicted fault condition for the automatic access system.

14. A computer-implemented method of detecting fault conditions of an automatic access system, the computer-implemented method comprising:
collecting, by an energy metering component, energy usage data associated with an operation of the automatic access system;
analyzing, by a processor, the energy usage data to determine an energy usage over time associated with the operation of the automatic access system;
comparing, by the processor, the energy usage over time to a baseline energy usage over time associated with the automatic access system;
based on the comparing, determining, by the processor, that the energy usage over time differs from the baseline energy usage over time by at least a threshold amount; and
after determining that the energy usage over time differs from the baseline energy usage over time by at least the threshold amount, availing an electronic notification via a user electronic device associated with the automatic access system.

15. The computer-implemented method of claim 14, wherein collecting the energy usage data comprises:
collecting, by the energy metering component, the energy usage data associated with the operation of an access mechanism of the automatic access system.

16. The computer-implemented method of claim 14, wherein comparing the energy usage over time to the baseline energy usage over time comprises:
identifying the baseline energy usage over time based on a type of the operation of the automatic access system; and
comparing, by the processor, the energy usage over time to the baseline energy usage over time.

17. The computer-implemented method of claim 14, wherein comparing the energy usage over time to the baseline energy usage over time associated with the automatic access system comprises:
calculating, at multiple points in time, multiple differences between the energy usage over time and the baseline energy usage over time.

18. The computer-implemented method of claim 17, wherein determining that the energy usage over time differs from the baseline energy usage over time by at least the threshold amount comprises:
calculating, based on the multiple differences, an overall difference between the energy usage over time and the baseline energy usage over time; and
determining that the overall difference at least meets the threshold amount.

19. The computer-implemented method of claim 14, wherein availing the electronic notification comprises:
generating the electronic notification to identify a potential fault condition associated with the automatic access system; and
transmitting the electronic notification to the user electronic device.

20. The computer-implemented method of claim 14, wherein the processor associated with a server computer that is remote from the energy metering component, and wherein analyzing the energy usage data comprises:
receiving, by the processor from the energy metering component, the energy usage data; and
analyzing, by a processor, the energy usage data to determine the energy usage over time associated with the operation of the automatic access system.
